(19) United States
(12) Patent Application Publication
(10) Pub. No.: US 2026/0311000 A1
(43) Pub. Date: Oct. 8, 2026

(54) DYNAMIC PARALLELISM

(71) Applicant: NVIDIA Corporation, Santa Clara, CA (US)

(72) Inventors: Przemyslaw Dominik Podczasi, Brwinów (PL); Piotr Michal Tarasiewicz, Warsaw (PL); Jakub Tomasz Kosek, Warsaw (PL); Piotr Marcin Marcinkiewicz, Wolomin (PL)

(21) Appl. No.: 19/255,550

(22) Filed: Jun. 30, 2025

Related U.S. Application Data
(60) Provisional application No. 63/783,062, filed on Apr. 3, 2025.

(51) Int. Cl. G06N 5/04; G06F 40/40

(52) U.S. Cl. CPC G06N 5/04; G06F 40/40

(57) ABSTRACT

In various examples, one or more neural networks are to be performed by a number of processors. The neural network may be reconfigured during inferencing such that the number of processors that start the inferencing is different from the number of processors that finish the inferencing.

### CROSS-REFERENCE TO RELATED APPLICATION

This application claims the benefit of U.S. Provisional Application No. 63/783,062, filed on Apr. 3, 2025, the contents of which are hereby incorporated by reference in their entirety.

### FIELD

At least one embodiment pertains to processing resources used to perform training and/or inferencing using neural networks. For example, at least one embodiment pertains to processors or computing systems used to reconfigure neural networks during inferencing to be performed by a different number of processors.

### BACKGROUND

Neural network computations may be performed by multiple processors, such as graphics processing units (GPUs). The computing resources used to perform these computations can vary according to properties of the neural network. Techniques to allocate computing resources to perform neural network computations can be improved.

### SUMMARY

Embodiments of the present disclosure relate to dynamic parallelism. Systems and methods are disclosed that cause one or more neural networks to be reconfigured to use a different number of processors to perform a later stage of inferencing than a number of processors that were used in an earlier stage of the inferencing. This is in contrast to conventional systems where such a reconfiguration would require that inferencing be restarted in order to use a different number of processors.

### BRIEF DESCRIPTION OF THE DRAWINGS

The present systems and methods for dynamic parallelism are described in detail below with reference to the attached drawing figures, wherein:

FIG. 1 illustrates a system incorporating dynamic parallelism, in accordance with some embodiments of the present disclosure;

FIG. 2 illustrates a system using dynamic parallelism, according to at least one embodiment;

FIG. 3 illustrates a system using dynamic parallelism and multiple generate workers, according to at least one embodiment;

FIG. 4 is a flow diagram showing a method for dynamic parallelism, in accordance with some embodiments of the present disclosure;

FIG. 5 illustrates a neural network using dynamic parallelism, according to at least one embodiment;

FIG. 6 is a flow diagram showing a method for a neural network using dynamic parallelism, in accordance with some embodiments of the present disclosure;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIG. 8 is a block diagram of an example computing device suitable for use in implementing at least some embodiments of the present disclosure; and

FIG. 9 is a block diagram of an example data center suitable for use in implementing at least some embodiments of the present disclosure.

### DETAILED DESCRIPTION

During inferencing by a neural network, the neural network may be reconfigured such that information for performing the neural network may be redistributed among a different number of processors so that the different number of processors can perform subsequent stages of the neural network, in response to various conditions being met. For example, if performance of the neural network would benefit from a larger number of processors that are initially unavailable, the reconfiguring may occur during inferencing once additional processors do become available, where inferencing refers to a series of computations or related operations to generate an output of a neural network. Thus, the number of processors used to perform the neural network can be changed, according to techniques described herein, even if the neural network is in the middle of generating an output. In at least one embodiment, reconfiguring a neural network comprises adjusting the neural network and/or other information such that the neural network is to be performed by a different number of processors. This is an improvement over prior techniques, where such a reconfiguration would require that inferencing be restarted.

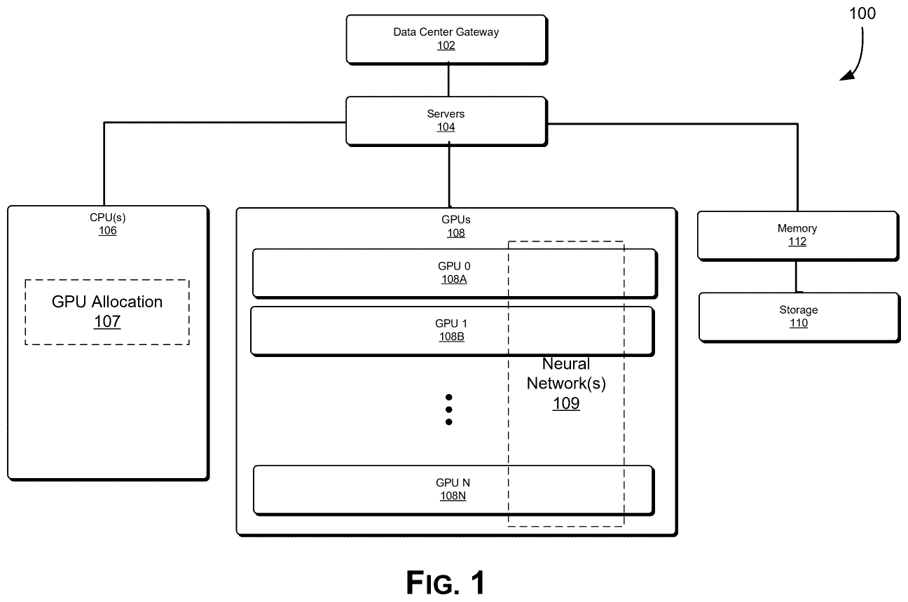

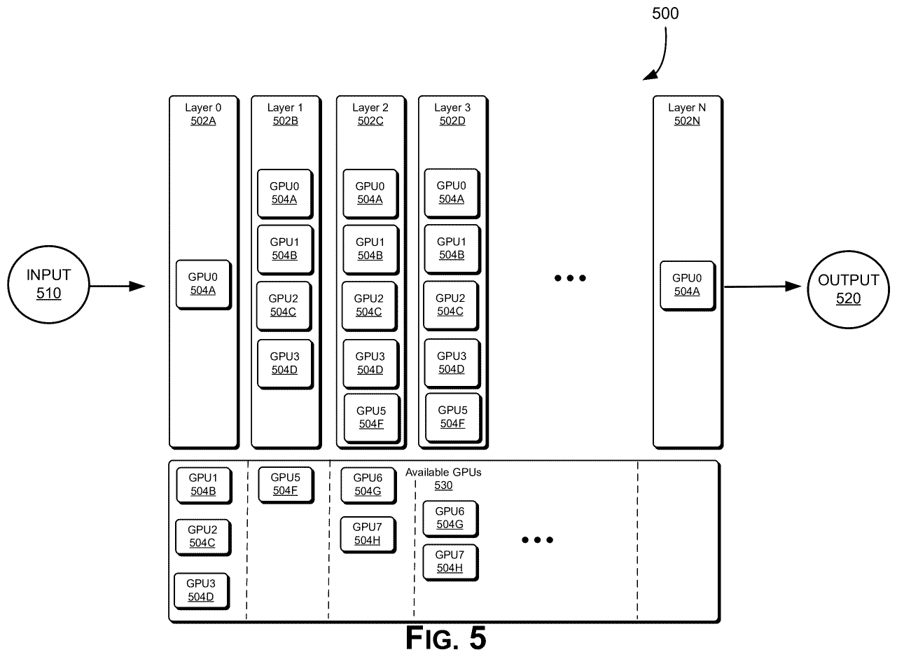

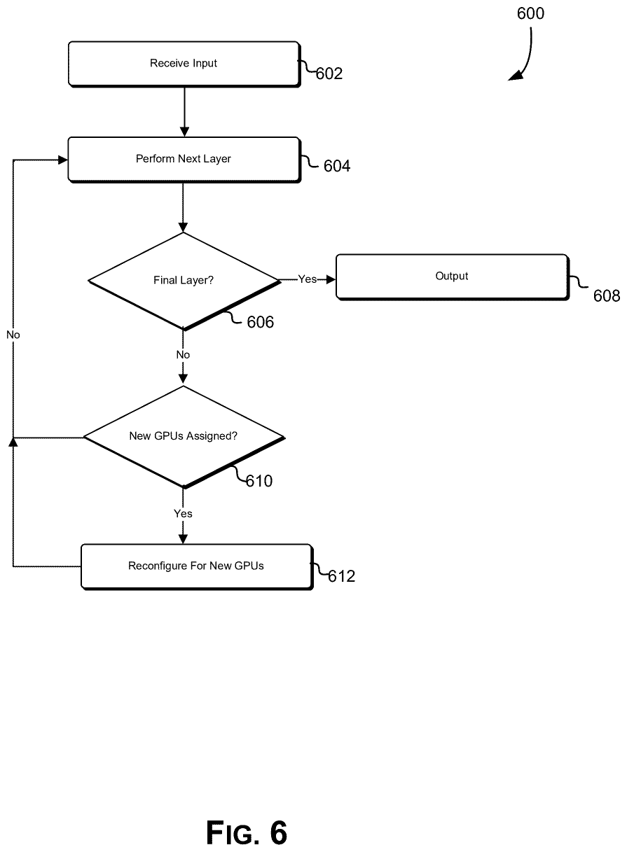

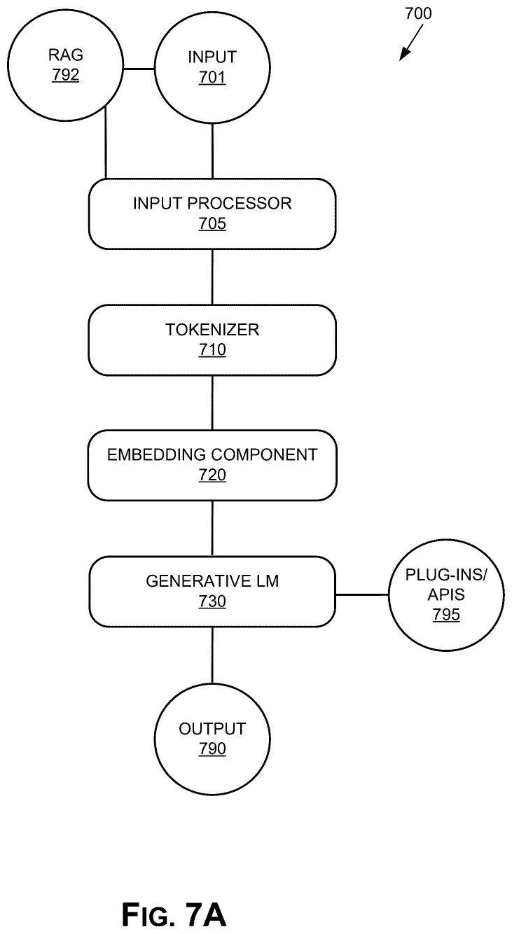

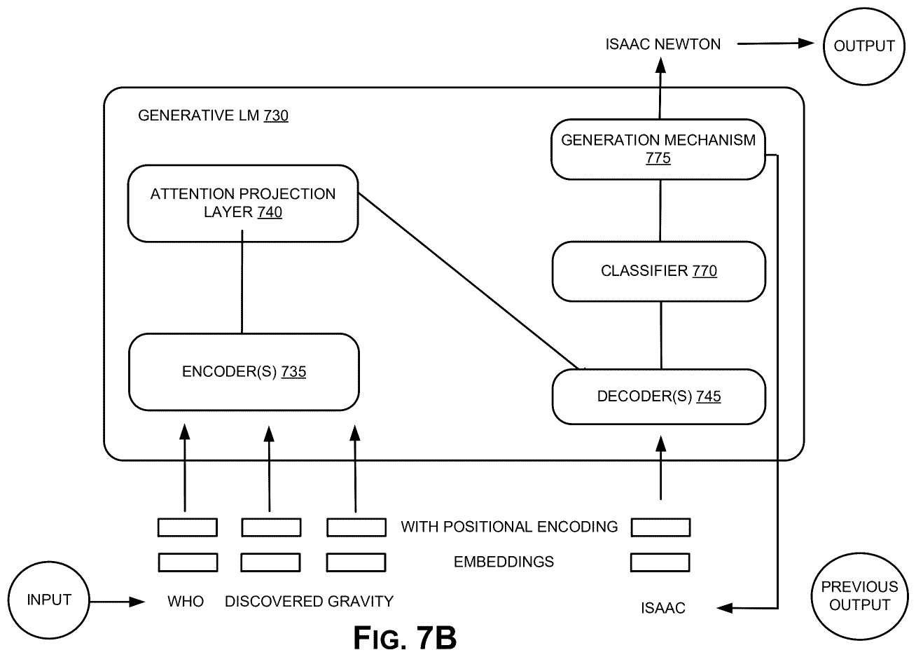

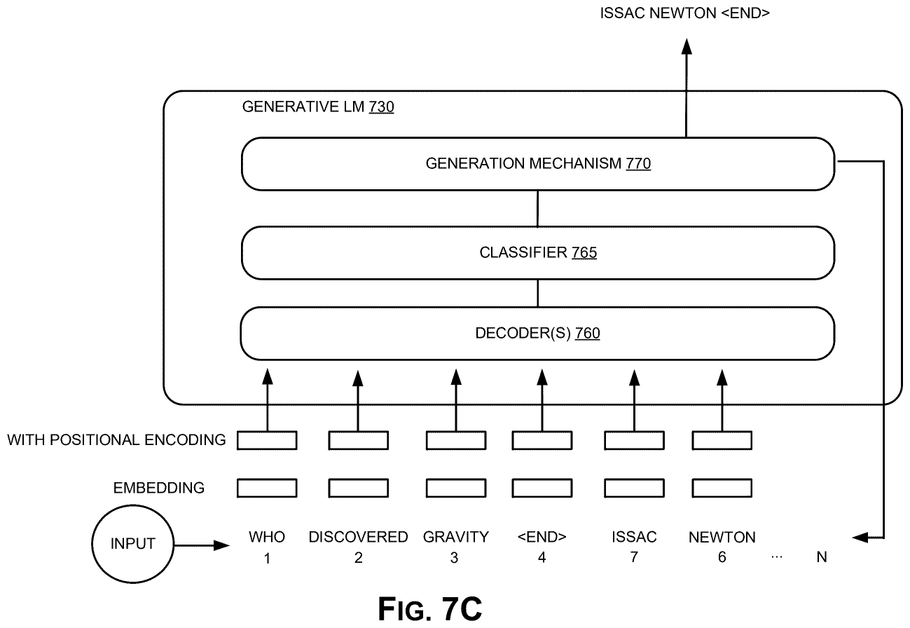

FIG. 1 is a system 100 using dynamic parallelism, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 5A-5C), one or more computing devices or components thereof (e.g., as described in FIG. 6), and/or one or more data centers or components thereof (e.g., as described in FIG. 7).

In at least one embodiment, the system 100 includes a data center gateway 102 and servers 104. In at least one embodiment, data center gateway 102 receives incoming data streams and includes hardware and associated software to receive and distribute data from the data streams to other components of the system 100. The hardware may include, as non-limiting examples, network interface cards (NICs) to facilitate reception and transmission of data packets, routers and switches to manage data flow between external sources of the data streams and internal components of the data center, firewalls to filter incoming data streams to prevent unauthorized access, and load balancers to distribute incoming data traffic across servers 104 to optimize resource usage.

In at least one embodiment, servers 104 are computing devices that host applications and provide services to end-users. In at least one embodiment, these services include file storage. For example, the servers 104 may be equipped with CPUs 106, GPUs 108, storage 110, and memory 112 to manage diverse computational workloads. The servers 104 may be interconnected through a network infrastructure to facilitate communication and data exchange therebetween.

In at least one embodiment, the CPUs 106 of the servers 104 perform tasks, such as executing instruction and computations. For example, data may be processed by performing arithmetic and logic operations. The CPUs 106 may interface with other components of the servers 104 to coordinate performance of the tasks. For example, the CPUs 106 may provide instructions to the GPUs 108 to perform parallel processing of data.

In at least one embodiment, the GPUs 108 accelerate performance of tasks via parallel processing. As an example, the GPUs 108 may perform large-scale computations, such as those used for machine learning and data analytics. By utilizing the GPUs 108 in conjunction with the CPUs 106, computational efficiencies of the servers 104 may be increased.

In at least one embodiment, the storage 110 is a component of the servers 104 that performs data storage. For example, the storage 110 may include storage media, such as hard drives and solid-state drives, to provide high-capacity and high-seed data access. The storage 110 may maintain data integrity and support rapid data retrieval when data is requested for processing.

In at least one embodiment, the memory 112 is a component of the servers 104 that provides data access. For example, the memory 112 may be random-access memory (RAM) that facilitates rapid access to data, thereby enhancing a speed and efficiency of tasks performed at the system 100. The memory 112 may be managed to optimize resource allocation and performance.

In at least one embodiment, GPUs 108 perform one or more neural networks 109. In at least one embodiment, neural networks 109 comprise a large language model (LLM). In at least one embodiment, CPUs 106 perform GPU allocation 107. In at least one embodiment, GPU allocation is performed by one or more or GPUs 108. GPU allocation may also be performed by a combination of CPUs 106 and GPUs 108, or by any other suitable processor. GPU allocation 107 causes different portions of the neural networks 109 to be performed using a different number of GPUs 108. For example, a first portion of a neural network 109 may only require the use of one GPU (and would not benefit from additional GPUs), so only one of GPUs 108 are allocated to this portion and the rest of GPUs 108 are made available for other tasks. Continuing with this example, a second portion of the neural network 109 may be memory-intensive, so GPU allocation 107 causes this portion to be performed using all available GPUs 108. In at least one embodiment, GPUs 108 are all part of the same computing node, and/or GPUs 108 are re-allocated between performance of portions of neural network 109, without needing to re-perform the previously performed portions of neural network 109.

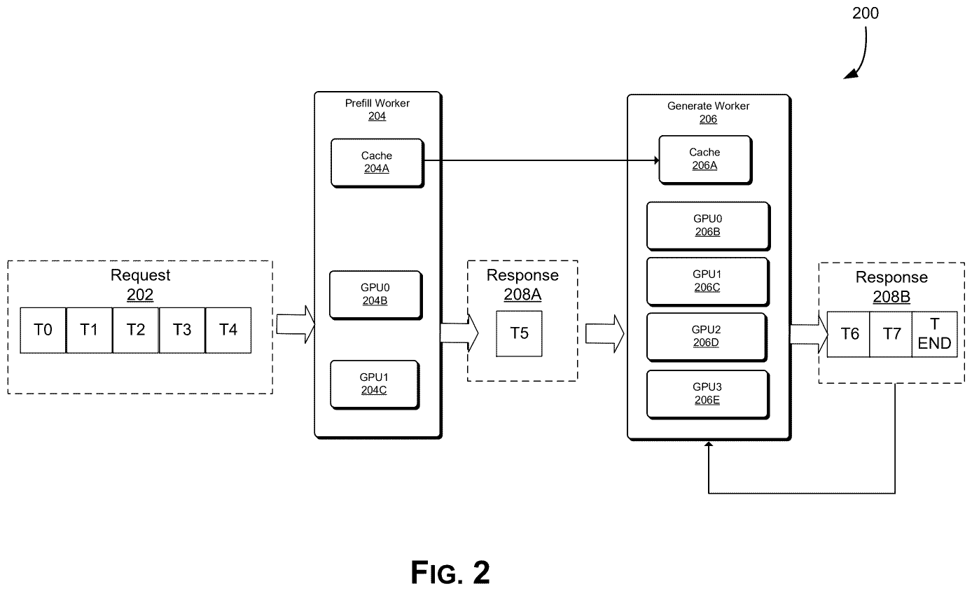

FIG. 2 illustrates a system 200 using dynamic parallelism, according to at least one embodiment. In at least one embodiment, system 200 is implemented using at least CPUs 106 and/or GPUs 108 illustrated in FIG. 1. In the illustrated example, system 200 includes a prefill worker 204 and a generate worker 206 comprising two and four GPUs, respectively. In at least one embodiment, system 200 implements an LLM. In at least one embodiment, system 200 implements any other neural network.

In the illustrated example, system 200 receives a request 202 at prefill worker 204. Request 202 may comprise a number of tokens. A token may be a portion of an input word or phrase. For example, each token may represent a word, syllable, letter, phoneme, or any other suitable portion. While FIG. 2 shows five tokens within request 202, any suitable number of tokens may be used.

Prefill worker 204 may be used by a neural network (e.g., an LLM) to generate a portion of a response 208A to the request 202, based on the request 202. In at least one embodiment, this portion 208A is generated based on all tokens within the request 202. In at least one embodiment, this portion 208A is generated based on a subset of all tokens within the request 202. The portion 208A may include a first token (e.g., “T5” as illustrated) of the response 208. Prefill worker 204 may use a cache 204A to store, for example, intermediate results of computations, configuration information, and/or generated tokens. Prefill worker 204 may generate the first token (or additional tokens) using one or more GPUs. For example, as illustrated, prefill worker 204 uses GPU0 204B and GPU1 204C, but a greater number of GPUs, one GPU, and/or any other suitable processors may be used.

Generate worker 206 may be used by the neural networks to generate an additional portion of the response 208B. In at least one embodiment, this portion 208B is generated based on at least the token(s) included in the portion 208A. Generate worker 206 may generate one token of 208B at a time (e.g., T6, T7, . . . ) and iterate until a final token (e.g., T END) is reached. Generate worker 206 may iteratively generate these tokens based on the request 202 and/or previously generated tokens within the response 208. In at least one embodiment, data from cache 204A is copied to cache 206A to be used by generate worker 206.

In at least one embodiment, generate worker 206 uses a different number of GPUs (e.g., GPU0 206B, GPU1 206C, GPU2 206D, and GPU3 206E) than the number of GPUs used by prefill worker 204. Such an adjustment may be desirable because, for example, prefill worker 204 would not benefit from additional GPUs, generate worker 206 requires a greater amount of memory and would benefit from additional GPUs. While FIG. 2 shows four GPUs, generate worker 206 may use any suitable number of GPUs. The number of GPUs to be used may be adjusted, e.g., by a CPU performing GPU allocation 107 as illustrated in FIG. 1, between prefill worker 204 and generate worker 206 based at least partially on, for example, availability of GPUs, expected performance gain, and expected costs of switching. In the illustrated example of FIG. 2, it would have been determined that the cost of reconfiguring the model (e.g., data structures within cache 206A, etc.) to use four GPUs instead of two plus the cost of reassigning GPU2 206D and GPU3 206E to be used by generate worker 206 is outweighed by the expected performance gain of using four GPUs. These values may be determined experimentally, determined and/or estimated using a heuristic, determined and/or estimated using an algorithm, and/or determined and/or estimated using any other suitable technique.

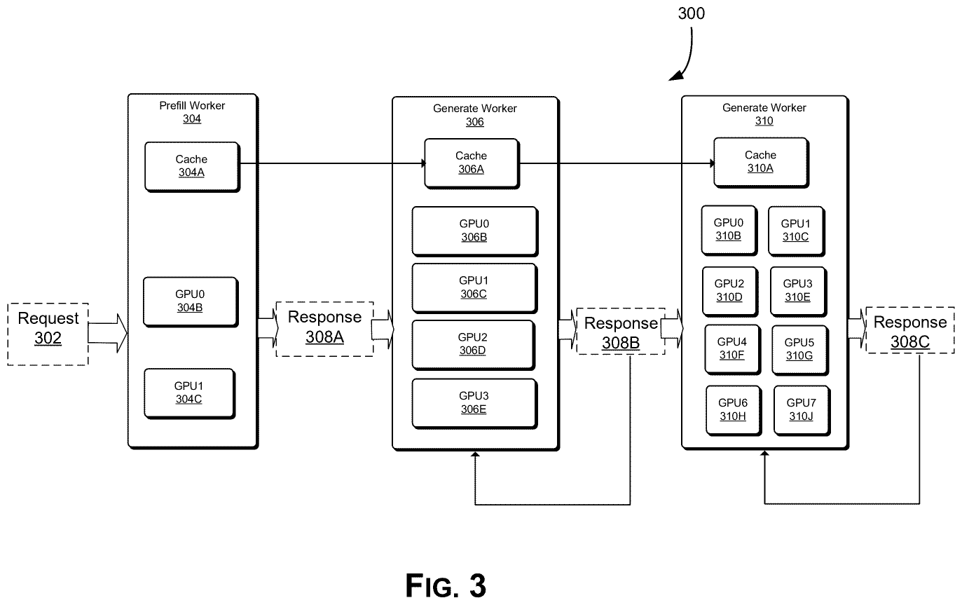

FIG. 3 illustrates a system 300 using dynamic parallelism and multiple generate workers, according to at least one embodiment. In at least one embodiment, system 300 is implemented using at least CPUs 106 and/or GPUs 108 illustrated in FIG. 1. In the illustrated example, system 300 includes a prefill worker 304 and generate workers 306 and 310, comprising two, four, and eight GPUs, respectively. In at least one embodiment, system 300 implements an LLM. In at least one embodiment, system 300 implements any other neural network. In at least one embodiment, system 300 includes more than one prefill worker and/or more than two generate workers.

In the illustrated example, system 300 receives a request 302 at prefill worker 304. In at least one embodiment, request 302 is request 202. Request 302 may comprise a number of tokens (not illustrated). A token may be a portion of an input word or phrase. For example, each token may represent a word, syllable, letter, phoneme, or any other suitable portion.

Prefill worker 304 may be used by a neural network (e.g., an LLM) to generate a portion of a response 308A to the request 302, based on the request 302. In at least one embodiment, prefill worker 304 is prefill worker 204. In at least one embodiment, this portion 308A is generated based on all tokens within the request 302. In at least one embodiment, this portion 308A is generated based on a subset of all tokens within the request 302. The portion 308A may include a first token (not shown) of the response 308. Prefill worker 304 may use a cache 304A to store, for example, intermediate results of computations, configuration information, and/or generated tokens. Prefill worker 304 may generate the first token (or additional tokens) using one or more GPUs. For example, as illustrated, prefill worker 304 uses GPU0 304B and GPU1 304C, but a greater number of GPUs, one GPU, and/or any other suitable processors may be used.

Generate worker 306 may be used by the neural networks to generate an additional portion of the response 308B. In at least one embodiment, this portion 308B is generated based on at least the token(s) included in the portion 308A. Generate worker 306 may generate one token of 308B at a time and iterate until the neural networks are to be reconfigured to use a different number of processors. Generate worker 306 may iteratively generate these tokens based on the request 302 and/or previously generated tokens within the response 308.

In at least one embodiment, data from cache 304A is copied to cache 306A to be used by generate worker 306. In at least one embodiment, this data includes weights of the neural networks, or any other data necessary to perform the neural networks.

In at least one embodiment, generate worker 306 uses a different number of GPUs (e.g., GPU0 306B, GPU1 306C, GPU2 306D, and GPU3 306E) than the number of GPUs used by prefill worker 304. Such an adjustment may be desirable because, for example, prefill worker 304 would not benefit from additional GPUs, and/or generate worker 306 requires a greater amount of memory and would benefit from additional GPUs. While FIG. 3 shows four GPUs, generate worker 306 may use any suitable number of GPUs. The number of GPUs to be used may be adjusted, e.g., by a CPU performing GPU allocation 107 as illustrated in FIG. 1, between prefill worker 304 and generate worker 306 based at least partially on, for example, availability of GPUs, expected performance gain, and expected costs of switching. In the illustrated example of FIG. 3, it would have been determined that the cost of reconfiguring the model (e.g., data structures within cache 306A, etc.) to use four GPUs instead of two plus the cost of reassigning GPU2 306D and GPU3 306E to be used by generate worker 306 is outweighed by the expected performance gain of using four GPUs. These values may be determined experimentally, determined and/or estimated using a heuristic, determined and/or estimated using an algorithm, and/or determined and/or estimated using any other suitable technique.

Generate worker 310 may be used by the neural networks to generate another additional portion of the response 308C. In at least one embodiment, this portion 308C is generated based on at least the token(s) included in the portion 308C. Generate worker 310 may generate one token of 308C at a time and iterate until an end token (not shown) is reached. Generate worker 310 may iteratively generate these tokens based on the request 302 and/or previously generated tokens within the response 308.

In at least one embodiment, data from cache 306A is copied to cache 310A to be used by generate worker 310. In at least one embodiment, this data includes weights of the neural networks, or any other data necessary to perform the neural networks.

In at least one embodiment, generate worker 310 uses a different number of GPUs (e.g., GPU0-GPU7 310B, 310C, 310D, 310E, 310F, 310G, 310H, 310J) than the number of GPUs used by prefill worker 304 and/or generate worker 306.

As discussed above, such an adjustment may be desirable because of differing resources requirements. Such an adjustment may also occur in response to a number of processors (e.g., GPU4-GPU7) becoming available.

In the example of FIG. 3, during performance of generate worker 307, GPU4 310F, GPU5 310G, GPU6 310H, and GPU7 310J become available for use. In response, a processor (e.g., a CPU performing GPU allocation 107 as illustrated in FIG. 1) may calculate and/or predict a performance increase that would result from creating generate worker 310 to use all eight available GPUs to continue performing inferencing of the neural networks. The processor performing GPU allocation may also calculate and/or predict a cost of reconfiguring the neural networks to be performed by generate worker 310, and/or a cost of reconfiguring the GPUs to be included in generate worker 310. The processor performing GPU allocation may also compare this performance increase to the cost(s). If, for example, as illustrated in FIG. 3, the performance increase (and/or the difference between the performance increase and the cost(s)) is greater than a threshold value, generate worker 310 is created to continue performing inferencing of the neural networks. Otherwise, generate worker may continue performing the inferencing (not shown).

While FIG. 3 shows one prefill worker 304 and two generate workers 306 and 310, other embodiments may include different numbers of prefill workers, different numbers of generate workers, and/or different types of neural network portions.

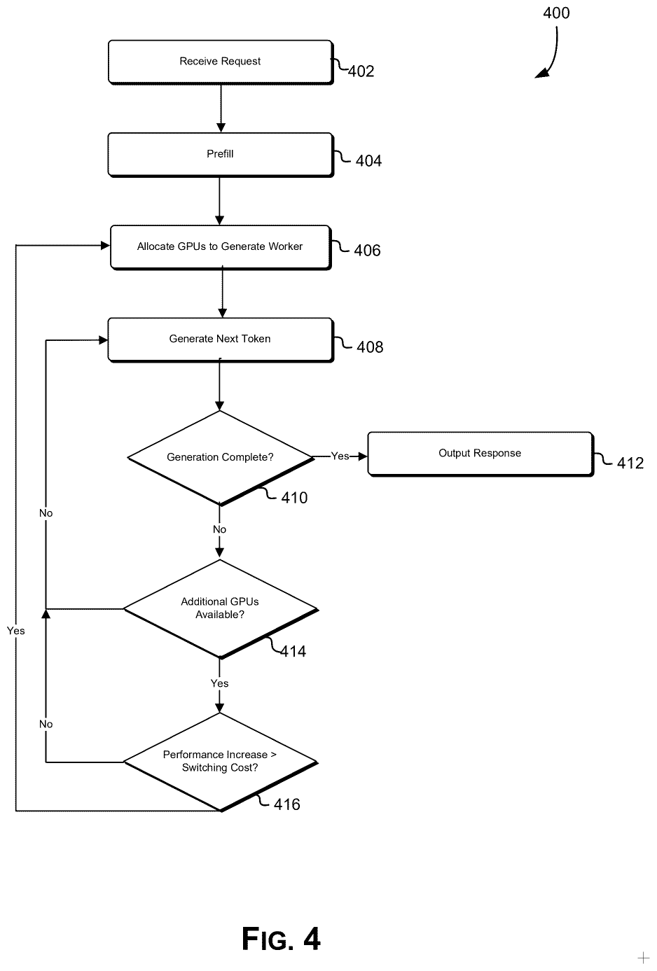

Now referring to FIG. 4, each block of method 400, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 400 is described, by way of example, with respect to the system of FIG. 1. However, this method may additionally or alternatively be executed by any one system, or any combination of systems, including, but not limited to, those described herein.

FIG. 4 is a flow diagram showing a method 400 for dynamic parallelism, in accordance with some embodiments of the present disclosure. The method 400, at block 402, includes receiving a request for (e.g., request 202 and/or request 302) via a processor such as a GPU (e.g., one of GPUs 108 and/or one of CPUs 106). As discussed with respect the FIGS. 2 and 3, the request may comprise a number of tokens to be input to one or more neural networks such as an LLM.

At block 404, one or more processors (e.g., GPUs, as illustrated in FIGS. 2 and 3) perform prefill (e.g., via prefill worker 204 and/or prefill worker 304). In at least one embodiment, prefill comprises performing inferencing using all tokens included in the request to generate at least a first response token (e.g., included in response portion 208A and/or 308A). Prefill may also comprise performing inferencing using only some of the tokens included in the request.

At block 406, a number of GPUs (or other suitable type of processor) is allocated to a generate worker (e.g., generate worker 206, generate worker 306, and/or generate worker 310). This allocation may be performed by a processor such as CPU(s) 106 illustrated in FIG. 1 performing GPU allocation 107. This allocation may also include copying contents of a cache (e.g., as illustrated in FIGS. 2 and 3) and/or reconfiguring the neural network to be performed by a different number of processors. At block 408, the generate worker performs inferencing to generate a next token (e.g., based on the request received at block 402 and the token generated at block 404, and/or any other previously generated tokens).

At block 410, a processor (e.g., one or more GPUs comprising the generate worker) determines whether the generation is complete. For example, generation may be complete once the generate worker generates an end token (e.g., as illustrated as part of response 208B in FIG. 2) in block 408. If, at block 410, generation is complete, method 400 terminates at block 412 where the response comprising the generated tokens is output. If, at block 410, generation is not complete, method 400 proceeds to block 414.

At block 414, a processor (e.g., one or more GPUs comprising the generate worker, or any other suitable processor such as a CPU) determines whether additional GPUs are available for use by method 400. If no additional GPUs are available, generation continues using the current generate worker, and method 400 returns to block 408. If additional GPUs are available, method 400 proceeds to block 416.

At block 416, a processor (e.g., one or more GPUs comprising the generate worker, or any other suitable processor such as a CPU) determines and/or predicts whether a performance increase to be achieved by using one or more of the additional available GPUs is greater than a cost(s) associated with this reconfiguration, for example as discussed with reference to FIGS. 2 and 3. If the performance increase is not greater than the switching cost, method 400 returns to block 408. If the performance is greater than the switching cost, method 400 returns to block 406 to reallocate GPUs to a generate worker to include at least one of the additional available GPUs (e.g., generate worker 310 illustrated in FIG. 3).

FIG. 5 illustrates a neural network 500 using dynamic parallelism, according to at least one embodiment. In at least one embodiment, neural network 500 is performed by GPUs 108 illustrated in FIG. 1. In the illustrated example, neural network 500 includes a plurality of layers, 502A-502N, performed sequentially. However, other embodiments may include layers performed in parallel, or iterations of the same layers performed repeatedly. Neural network 500 may be, for example, neural network 109 and/or a neural network associated with systems 200 or 300. Neural network 500 may also be multiple neural networks.

As illustrated in FIG. 5, neural network 500 receives an input 510 (e.g., request 302) and produces an output 520 (e.g., response 308), and is performed, at any given layer by at least one of GPU0-GPU7 504A-504B.

In the illustrated example, performance of neural network 500 begins with layer 0 being performed by GPU0 504A and, during performance of layer 0 504A, available GPUs 530 is caused to include GPU1 504B, GPU2 504C, and GPU3 504D. At layer 1 502B, previously available GPUs 504B, 504C, and 504D are used for performance of neural network 500, and GPU5 504F also becomes available. Similarly, at layer 2 502C, GPU5 504F is added to GPU0-GPU4 for performance of neural network 500, and GPU6 504G and GPU7 504H also become available. At layer 3 502D, however, GPU0-GPU5 continue performance of neural network 500, but GPU6 504G and GPU7 504H remain available. GPU6 504G and GPU7 504H may remain available, for example, if the cost of reconfiguring neural network 500 to use seven GPUs outweighs any potential performance increase. Performance of neural network 500 continues until layer N 502N, performed by GPU0 504A to produce output 520. In the illustrated example, layer N 502N is performed only by GPU0 504A because no other GPUs are available.

FIG. 6 is a flow diagram showing a method 600 for a neural network using dynamic parallelism, in accordance with some embodiments of the present disclosure. The method 600, at block 602, includes receiving an input for the neural network (e.g., input 510). As discussed with respect the FIGS. 2 and 3, the input may comprise a number of tokens to be input to one or more neural networks such as an LLM.

At block 604, one or more processors (e.g., GPUs, as illustrated in FIGS. 2 and 3) perform a next (or first) layer of a neural network, for example as illustrated in FIG. 5. prefill (e.g., via prefill worker 204 and/or prefill worker 304). Block 604 may also include performing multiple layers.

At block 606, a processor (e.g., a CPU or GPU as illustrated in FIGS. 1-5) determines whether the layer performed in block 604 is the final layer to be performed. If so, method 600 proceeds to block 608 to produce an output (e.g., output 520).

Otherwise, method 600 proceeds to block 610. At block 610, a processor (e.g., a CPU or GPU as illustrated in FIGS. 1-5) determines whether new GPUs have been assigned for performance of the next layer of the neural network (e.g., via GPU allocation 107). If no new GPUs have been assigned, method 600 returns to block 604 to perform the next layer without changing the GPUs to be used. Assigning GPUs may include adding GPUs to the GPUs currently performing the neural network, removing GPUs from the GPUs currently performing the neural network, or a combination of adding and removing GPUs.

If new GPUs are assigned, method 600 proceeds to block 612. At block 612, a processor (e.g., a CPU or GPU as illustrated in FIGS. 1-5) reconfigures the neural network for performance by the new GPUs, for example as discussed with reference to FIGS. 2 and 3. After this reconfiguring, method 600 returns to block 604 to perform the next layer using the changed GPUs.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In at least one embodiment, the techniques and apparatuses discussed with reference to FIGS. 1-6 may at least partially implement one or more processors, comprising circuitry to cause a first number of a plurality of processors to be used to perform a first portion of one or more neural networks; determine a second number of the plurality of processors to be caused to perform a second portion of the one or more neural networks, wherein the second number of processors is determined based, at least in part, on an availability of the second number of processors subsequent to performing the first portion of the one or more neural networks; and cause the plurality of processors to be reconfigured to perform the second portion of inferencing using the second number of processors. The one or more neural networks may comprise at least a portion of a large language model. The plurality of processors may comprise one or more GPUs. The reconfiguration may be performed based on prediction of a performance increase to result from the use of the second number of processors to perform the second portion of inferencing. The first portion of inferencing may comprise a prefill portion of a large language model. The second portion of the inferencing may comprise a generate portion of a large language model. The one or more processors may be included in a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more vision language models (VLMs); a system for generating synthetic data; a system for generating synthetic data using AI; a system incorporating one or more virtual machines (VMs); a system implemented at least partially in a data center; and/or a system implemented at least partially using cloud computing resources.

### EXAMPLE LANGUAGE MODELS

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

In at least one embodiment, generative language model system 700 is used to at least partially implement performance, by a first number of a plurality of processors, a first portion of inferencing using one or more neural networks; performance, by a second number of the plurality of plurality of processors, a second portion of the inferencing using the one or more neural networks,, wherein the second number of the plurality of processors performs the second portion of inferencing based, at least in part, on prediction of a performance increase to result from use of the second number of processors.

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features—such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer710 of FIG. 7A) into tokens such as words, and each token is encoded (e.g., by the embedding component 720 of FIG. 97A) into a corresponding embedding (e.g., of size 712). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In at least one embodiment, generative LM 730 is used to at least partially implement performance, by a first number of a plurality of processors, a first portion of inferencing using one or more neural networks; performance, by a second number of the plurality of plurality of processors, a second portion of the inferencing using the one or more neural networks, wherein the second number of the plurality of processors performs the second portion of inferencing based, at least in part, on prediction of a performance increase to result from use of the second number of processors.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 770, and a generation mechanism 777 may generate a first token, and the generation mechanism 777 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 770 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 777 may select or sample a word or token based on a corresponding predicted probability (e.g., select the word with the highest predicted probability) and append it to the output from a previous pass, generating each word or token sequentially. The generation mechanism 777 may repeat the process, triggering successive decoder inputs and corresponding predictions until selecting or sampling a symbol or token that represents the end of the response, at which point, the generation mechanism 777 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 770 and the generation mechanism 777 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

In at least one embodiment, generative LM 730 is used to at least partially implement performance, by a first number of a plurality of processors, a first portion of inferencing using one or more neural networks; performance, by a second number of the plurality of plurality of processors, a second portion of the inferencing using the one or more neural networks,, wherein the second number of the plurality of processors performs the second portion of inferencing based, at least in part, on prediction of a performance increase to result from use of the second number of processors.

### EXAMPLE COMPUTING DEVICE

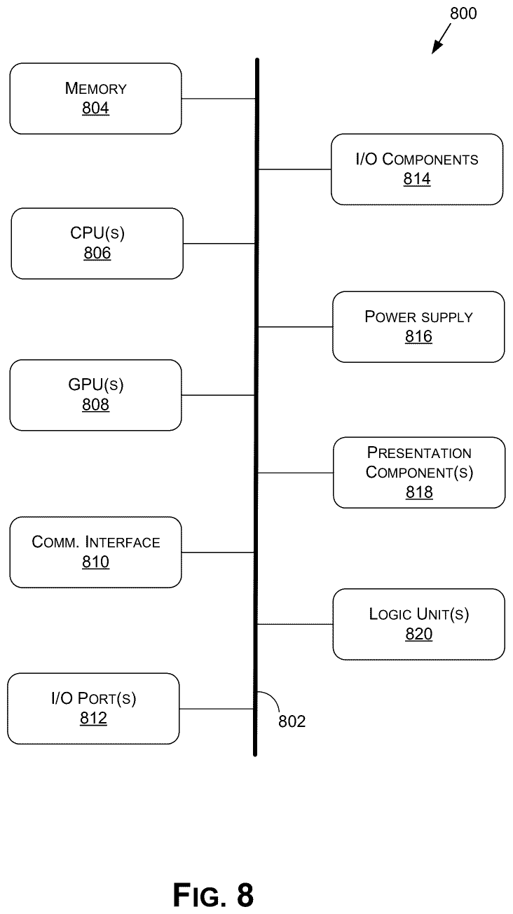

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 808, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 808 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

In at least one embodiment, computing device(s) 800 are used to at least partially implement performance, by a first number of a plurality of processors, a first portion of inferencing using one or more neural networks; performance, by a second number of the plurality of plurality of processors, a second portion of the inferencing using the one or more neural networks,, wherein the second number of the plurality of processors performs the second portion of inferencing based, at least in part, on prediction of a performance increase to result from use of the second number of processors.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 808 and/or GPUs 808 may include memory (e.g., the memory 804 may be representative of a storage device in addition to the memory of the GPUs 808, the CPUs 808, and/or other components). As such, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x88 processor implemented using Complex Instruction Set Computing (CISC). The computing device 800 may include one or more CPUs 808 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that allow the computing device 800 to communicate with other computing devices via an electronic communication network, included wired and/or wireless communications. The communication interface 810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may allow the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that allow detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to allow the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### EXAMPLE DATA CENTER

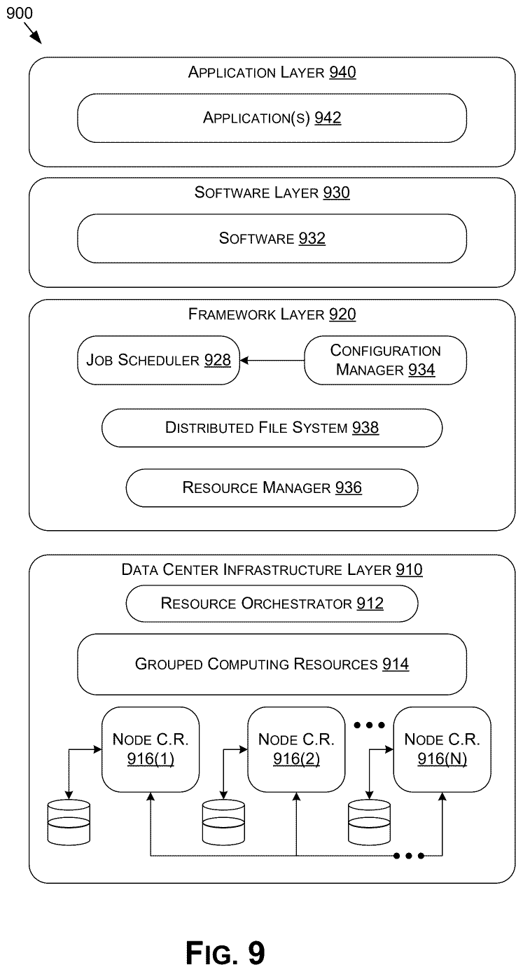

FIG. 9 illustrates an example data center 900 that may be used in at least one embodiments of the present disclosure. The data center 900 may include a data center infrastructure layer 910, a framework layer 920, a software layer 930, and/or an application layer 940.

In at least one embodiment, data center 900 is used to at least partially implement performance, by a first number of a plurality of processors, a first portion of inferencing using one or more neural networks; performance, by a second number of the plurality of plurality of processors, a second portion of the inferencing using the one or more neural networks,, wherein the second number of the plurality of processors performs the second portion of inferencing based, at least in part, on prediction of a performance increase to result from use of the second number of processors.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916(N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 928, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 928 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 928. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underutilized and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors, comprising circuitry to:
cause a first number of a plurality of processors to be used to perform a first portion of one or more neural networks;
determine a second number of the plurality of processors to be caused to perform a second portion of the one or more neural networks, wherein the second number of processors is determined based, at least in part, on an availability of the second number of processors subsequent to performing the first portion of the one or more neural networks; and
cause the plurality of processors to be reconfigured to perform the second portion of inferencing using the second number of processors.

2. The one or more processors of claim 1, wherein the one or more neural networks comprise at least a portion of a large language model.

3. The one or more processors of claim 1, wherein the plurality of processors comprises one or more graphics processing unit (GPU) processors.

4. The one or more processors of claim 1, wherein the reconfiguration is to be performed based, at least in part, on prediction of a performance increase to result from the use of the second number of processors to perform the second portion of inferencing.

5. The one or more processors of claim 1, wherein the first portion of the inferencing comprises performance of a prefill portion of a large language model.

6. The one or more processors of claim 1, wherein the second portion of the inferencing comprises performance of a generate portion of a large language model.

7. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

8. A method, comprising:
performing, using a first number of a plurality of processors, a first portion of inferencing using one or more neural networks;
performing, using a second number of the plurality of processors, a second portion of the inferencing using the one or more neural networks, wherein the second number of the plurality of processors performs the second portion of inferencing based, at least in part, on prediction of a performance increase to result from use of the second number of processors.

9. The method of claim 8, wherein the second number of the plurality of processors perform the second portion of inferencing by at least predicting of a cost of reconfiguring the plurality of processors to perform the one or more neural networks using the second number of processors.

10. The method of claim 8, wherein at least a portion of the plurality of processors comprises graphics processing units (GPUs) processors.

11. The method of claim 8, wherein the second number of processors is greater than the first number of processors.

12. The method of claim 8, wherein performing the first portion of inferencing comprises performing a prefill portion of a large language model.

13. The method of claim 8, wherein performing the second portion of inferencing comprises performing a generate portion of a large language model.

14. The method of claim 8, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

15. A processor, comprising: circuitry to cause one or more neural networks to be reconfigured to use a different number of processors to perform inferencing than a number of processors that began the inferencing.

16. The processor of claim 15, wherein the one or more neural networks comprise a large language model.

17. The processor of claim 15, wherein the processors to perform the inferencing comprise graphics processing units (GPUs).

18. The processor of claim 15, wherein the reconfiguration of the one or more neural networks is to be performed in response to determining that one or more additional processors are available to perform the inferencing.

19. The processor of claim 15, wherein the reconfiguration of the one or more neural networks is to be performed in response to predicting that a cost of performing the reconfiguring is to be less than a performance increase resulting from the reconfiguring.

20. The processor of claim 15, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
